(19) United States
(12) Patent Application Publication
(10) Pub. No.: US 2010/0322293 A1
(43) Pub. Date: Dec. 23, 2010

(54) COMMUNICATION BETWEEN SUBMERGED STATION AND AIRBORNE VEHICLE

(76) Inventors: Mark Rhodes, West Lothian (GB); Brendan Peter Hyland, Edinburgh (GB)

Correspondence Address: Goodwin Procter LLP;Attn: Patent Administrator, 135 Commonwealth Drive, Menlo Park, CA, 94025-1105, US

(21) Appl. No.: 12/844,198

(22) Filed: Jul. 27, 2010

(30) Foreign Application Priority Data
Jan. 14, 2008 (GB) 0800508.4

(51) Int. Cl. H04B 13/02

(52) U.S. Cl. 375/218

(57) ABSTRACT

The present invention discloses a system for digitally modulated radio communication directly between a submerged underwater station and an airborne station. Each of the underwater station and the airborne station has or is associated with a radio communications antenna. Suitable radio communications antennas include loop antennas, solenoid antennas, stacked multiple loop antennas, planar arrayed loop antennas, a multiple resonant loop antennas. In some embodiments, the communications antennas of the submerged underwater station and the airborne station are each deployed horizontally thereby improving the efficiency of the signal transfer between the submerged underwater station and the airborne station.

### CROSS-REFERENCE TO RELATED APPLICATIONS

This application claims priority to GB 0800508.4, filed Jan. 14, 2008, which application is fully incorporated herein by reference.

### FIELD OF USE

The present invention relates to a bi-directional digitally modulated radio system for communication between a station submerged in water and an airborne vehicle.

### DESCRIPTION OF THE RELATED ART

The under-water domain and airborne domain are very different environments and communication between the two presents many challenges.

Radio communication is commonplace in the “atmospheric”, through air environment and modern communications techniques readily facilitate worldwide communications through access to satellite links and long-range radio communications networks. Radio waves experience high attenuation in the partially conductive medium of water. This has lead to the dominant use of acoustic signaling techniques under water. However, acoustic signals experience a high level of attenuation as they cross the water to air interface and are effectively bounded by the subsea environment. Acoustic techniques do not present a practical method of communications from below the water to above.

In the past, acoustic signals received under the water have been relayed using a surface repeater “gateway” to receive an acoustic underwater signal and re-transmit the data as a conventional radio signal for reception by an in-air station. This type of system introduces the added complexity of a third system component (repeater buoy) and has several disadvantages. A surface repeater reveals the underwater vehicle's position and limits the mobility of the airborne and submerged vehicles. For complete mobility, the gateway needs to be mobile and this requires the added complexity of co coordinating the position of three vehicles; submerged, surface and airborne.

### SUMMARY OF THE INVENTION

According to one aspect of the present invention, there is provided a system for direct digitally modulated radio communication between a station submerged in seawater and an airborne vehicle.

According to another aspect of the present invention, there is provided a submerged station equipped with a radio modem and loop or solenoid antenna and an airborne vehicle equipped with a radio modem and loop or solenoid antenna.

According to another aspect of the present invention, there is provided a communications system where loop antennas deployed at the submerged station and airborne vehicle are aligned so that their plane is oriented parallel to the ground during level flight.

The communications system may include loop antennas; solenoid antennas; stacked multiple loops; planar arrayed loops; multiple resonant loops; co located transmit receive antennas; or half wave folded dipole antennas as electromagnetic transducers.

The communications system may operate using carrier frequencies below 100 kHz.

Embodiments of the present invention will now be described with reference to the accompanying figures in which:

### BRIEF DESCRIPTION OF DRAWINGS

FIG. 1 is a block diagram of a submerged underwater vehicle communicating directly with an airborne vehicle that relays a radio signal to a satellite;

FIG. 2 shows a loop antenna deployed around the periphery of an aircraft;

FIG. 3 is a block diagram of a communications transceiver for use in the submerged to airborne radio communications system;

FIG. 4 is a block diagram of radio receiver system;

FIG. 5 is a block diagram of radio transmitter system;

FIG. 6 shows a loop antenna orientation with reference to a Cartesian co ordinate system;

FIG. 7 shows a stacked loop antenna system;

FIG. 8 shows a planar arrayed antenna system;

FIG. 9 is a diagram of a multi resonant antenna structure;

FIG. 10 shows the relative frequency responses firstly of the antenna system of FIG. 9 and secondly of an isolated loop antenna system by way of comparison;

FIG. 11 shows a co located transmit and receive antenna, and

FIG. 12 shows a half wave folded dipole antenna.

### DETAILED DESCRIPTION

Underwater radio communications deliver several niche advantages over acoustic signaling methods. One advantage is the radio signal's ability to cross the water to air boundary and radio signaling forms the subject of this invention. Seawater is partially conductive and in this medium, radio attenuation increases rapidly with frequency. This has driven sub-sea radio communications systems toward operation at very low frequencies to maximize operational range. The nature and advantages of electromagnetic and/or magneto-inductive signals and of magnetic antennas for communication through water are discussed in United States patent application publication, 2006/286931 “Underwater Communications System and Method” Rhodes et al. the contents of which are hereby incorporated by reference. Long-range subsea radio communications systems typically operate below 100 kHz and in some cases the operating frequency can beneficially be lowered down to 1 Hz.

To maximize range, the communication link should operate at the lowest practical frequency required for the intended bandwidth of communication. The operating frequency of the systems described in this application will be below 100 kHz. The partially conductive nature of seawater greatly reduces the wavelength of a propagating electromagnetic wave, and so the wavelength at 100 kHz is 5 m for typical seawater with conductivity of 4 S/m compared to over 3 km wavelength in air.

Since the submerged and airborne vehicles must retain mobility they require a compact antenna structure. Wavelength related antenna structures are not practical for mobile vehicles communicating with carrier frequencies below 100 kHz. Loop or solenoid antennas are the best solution for a compact mobile antenna for both ends of the communications link as outlined in United States patent application publication, 2006/286931.

Digital modulation schemes are required for the transmission of data over a radio communications network. For example, analogue voice channels occupy a bandwidth of at least 4 kHz, which prevents efficient through water transmission. A carrier frequency well above 4 kHz, for example 40 kHz, is required to allow a practical percentage bandwidth. In comparison, a digitally modulated signal can implement compression algorithms to carry a voice channel over a reduced bandwidth hence a lower carrier signal with increased range capabilities.

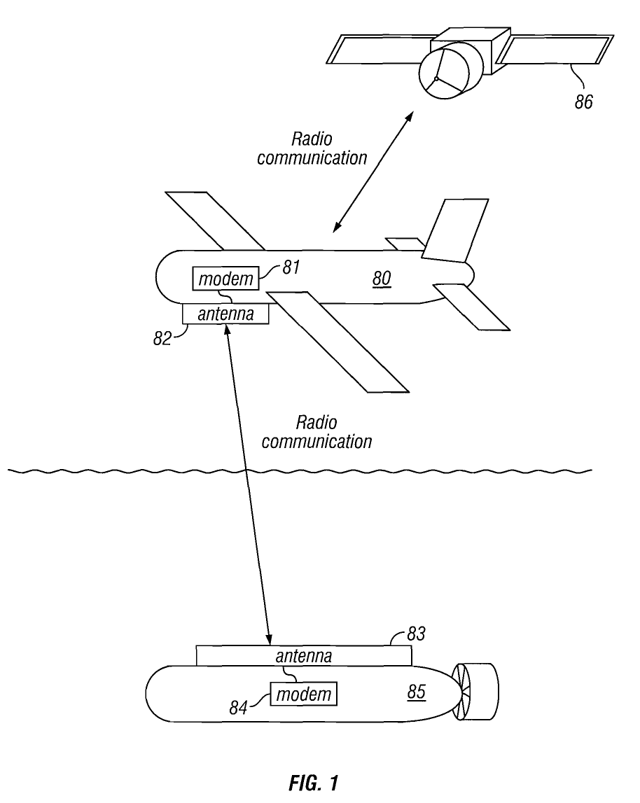

FIG. 1 is a diagram of a submerged underwater vehicle 85 equipped with radio modem 84 connected to antenna 83 which radiates and or receives an electromagnetic signal to effect radio communications with airborne vehicle 80. Airborne vehicle 80 is equipped with radio modem 81 that is connected to antenna 82 which radiates and or receives an electromagnetic signal to effect radio communications with submerged vehicle 85. If desired, a conventional radio communications link can then be used to implement a further data link to a remote satellite 86 for long-range relay of data. An airborne vehicle can act as a data collection vehicle in its own right or a mobile radio relay node for onward radio communications.

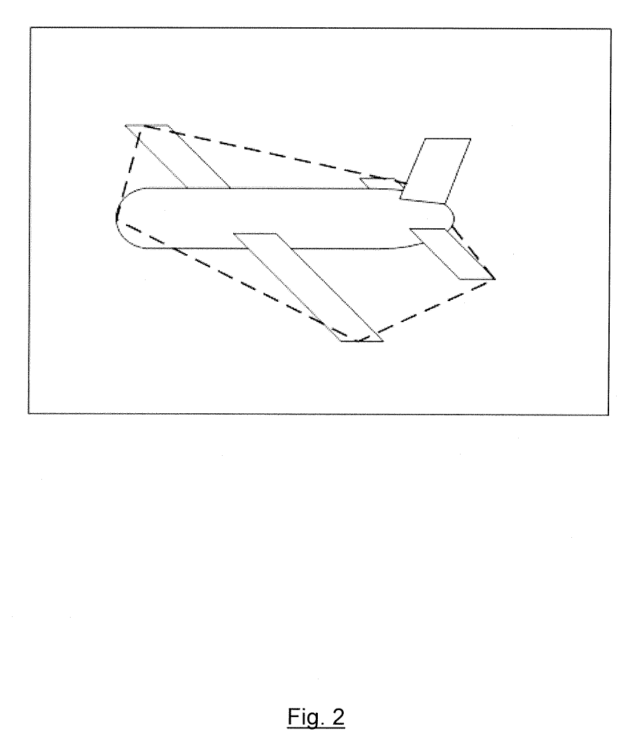

FIG. 2 is a diagram of an airborne vehicle with a dashed line representing one possible beneficial deployment of a loop antenna rigged from nose to wing tip to tail plane to wingtip to nose. This arrangement achieves a horizontal loop of maximum area within the limits of the aircraft dimensions. The antenna cable must be of low cross sectional area to minimize its impact on flight dynamics.

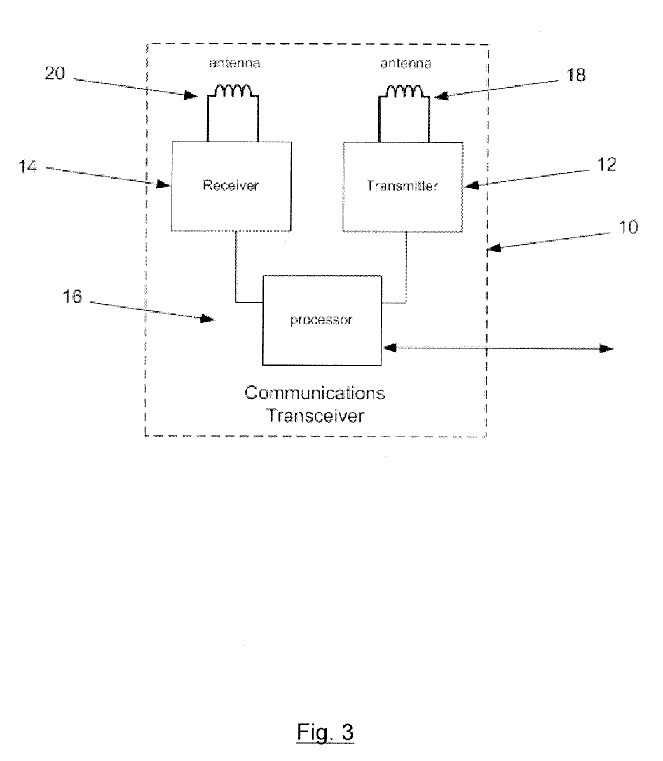

FIG. 3 shows a communications transceiver 10 that has a transmitter 12, a receiver 14 and a processor 16 that can be connected to an analogue or digital data interface (not shown). Both the transmitter and receiver 12 and 14 respectively have a waterproof magnetic coupled loop or solenoid antenna 18 and 20. Alternatively a single antenna can be shared between transmitter and receiver. This transceiver diagram represents further implementational details of the radio modem 81 and antenna 82 illustrated in FIG. 1. A similar transceiver will also perform the function of radio modem 84 and antenna 83 shown in FIG. 1.

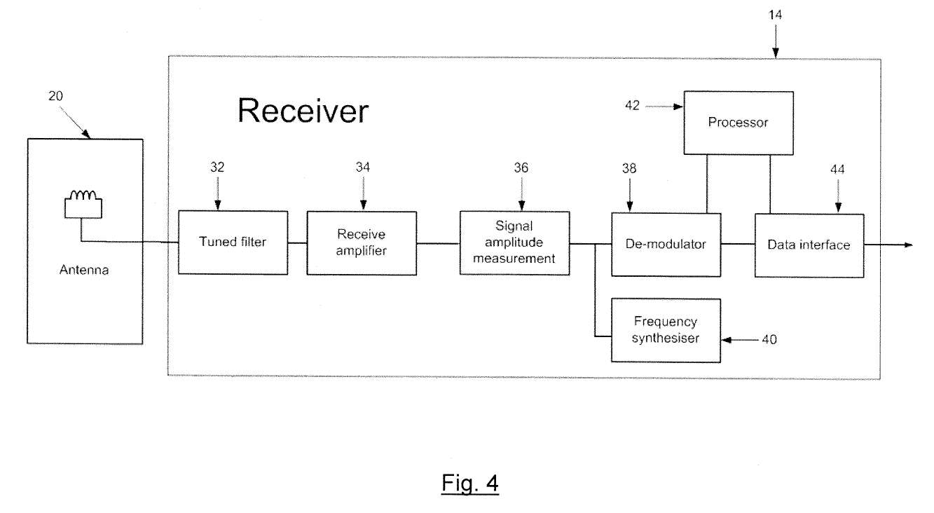

FIG. 4 shows an example of a receiver 14 for use with the transceiver of FIG. 3. As with the transmitter, this has an electrically insulated magnetic coupled antenna 20 adapted for underwater usage. This antenna is operable to receive magnetic field signals from the transmitter. Connected to the antenna 20 is a tuned filter 32 that is in turn connected to a receive amplifier 34. At the output of the amplifier 34 are a signal amplitude measurement module 36 that is coupled to a de-modulator 38 and a frequency synthesizer 40, which provides a local oscillator signal for down conversion of the modulated carrier. Connected to the de-modulator 38 are a processor 42 and a data interface 44, which is also connected to the processor 42. The data interface 44 is provided for transferring data from the receiver 14 to a control or monitoring means, such as another on-board processor, which may be located in the mobile vehicle.

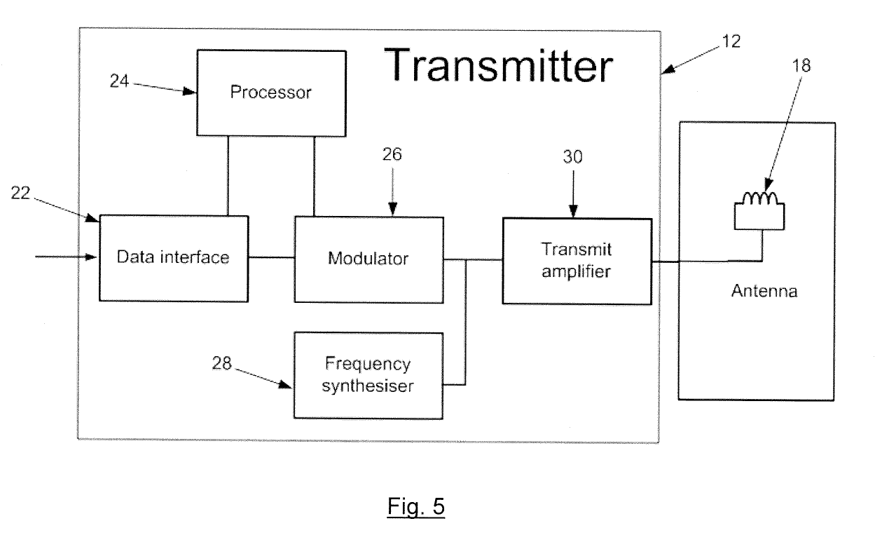

FIG. 5 shows an example of a transmitter 12 for use in the transceiver 10 of FIG. 3. This has a data interface 22 that is connected to each of a processor 24 and a modulator 26. The modulator 26 is provided to encode data onto a carrier wave. At an output of the modulator 26 are a frequency synthesizer 28 for that provides a local oscillator signal for up conversion of the modulated carrier and transmit amplifier 30, which is connected to the underwater, electrically insulated magnetic coupled antenna 18. In use, the transmitter processor 24 is operable to cause electromagnetic communication signals to be transmitted via the antenna at a selected carrier frequency.

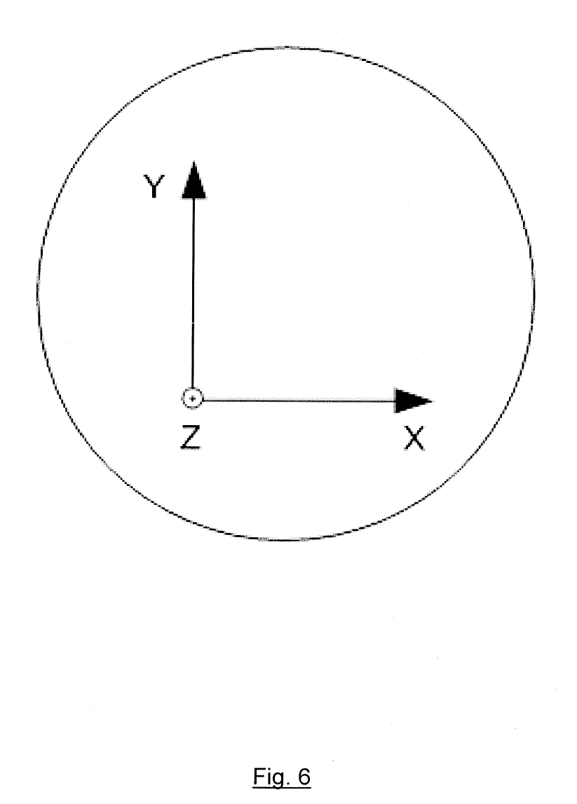

FIG. 6 illustrates a circular loop antenna in the x-y plane with the z axis perpendicular to the loop plane. A horizontal loop can be defined as one where plane x-y is oriented parallel to the ground. An alternative vertical loop has the z-axis parallel to the ground. While a vertical loop deployment can offer the most effective signal coupling between a submerged and airborne vehicle it has a directional field property, which requires co planar alignment of the two antennas for optimal performance. In a vertical loop deployment, freely maneuvering vehicles may result in loops that are aligned with perpendicular planes. This alignment represents a null in the coupled energy transferred between loops and is highly undesirable. Horizontal loop deployment is beneficial in the submerged station and airborne vehicle. In practice, airborne and submerged vehicles operate at relatively low pitch and roll angles. A horizontally deployed antenna will show a symmetrical field pattern in any plane in parallel with its x-y plane and this alignment can be substantially maintained during normal operation.

A magnetic loop carrying an alternating current produces three distinct field components. In addition to conductive attenuation, each term has a different geometric loss as we move distance r from the launching loop. An inductive term varies with a coefficient that includes a 1/r³ term, a quasi static term by 1/r² and a propagating wave by 1/r. All these terms can be employed in a radio communications link but have different field patterns with respect to the loop. While the radiating 1/r term is most efficiently coupled between two loops arranged in the same plane, the 1/r³ term couples strongly when two loops are arranged coaxially in parallel planes. The system described here utilizes all three elements of the electromagnetic field described above to implement a communications link.

Magnetic loops generate an alternating magnetic field whose strength is commonly defined by the well-understood textbook term, magnetic moment. For signal detection at greatest distance, the largest achievable magnetic moment is desirable. The magnetic moment is directly proportional to each of the three parameters: loop area, loop current, and number of loop turns. Equivalently, the magnetic moment is proportional to both the ampere-turn product of the loop and to the area of the loop. Thus, it is usually desirable that as many as possible of these three partially related parameters are designed to be as large as practical circumstances will permit.

To achieve a large magnetic moment, particular antenna and transmitter system designs may be constrained in practice by, for example: the practical maximum size (usually diameter) of antenna loop which can be deployed on the vehicle; the inductive reactance of the loop, which at a particular frequency is determined principally by the number of turns of a circular loop and its diameter; and the maximum drive voltage across the antenna loop which is available (or can be used safely) to cause signal current to flow, which current is in turn constrained also by the inductance; the maximum weight of conductor employed in the construction of the loop that is consistent with design and operation of the vehicle. Within these practical constraints, magnetic moment should be designed to be as large as possible for loops deployed in each of the communicating vehicles. Beneficial antenna implementations are discussed in our co-pending patent applications, which are listed below and their contents are incorporated here by reference.

United States patent application publication, 2009/160722 “Antenna formed of multiple loops”, Rhodes et al, the contents of which are hereby incorporated by reference, describes a method of antenna construction formed of multiple separate conducting loops so that larger magnetic moments may be achieved without requiring greater drive voltage. A multi turn loop is desirable to achieve a large magnetic moment but presents the difficulty of driving a large current through a high inductance. In this implementation a multi-turn loop is split into several loops of equal diameter, in the same plane and arranged around a common central axis. All sub loops share the flux generated by the others but the total inductance is divided among the sub loops. Each sub loop has a separate drive amplifier that only has to develop a driving voltage required to produce the desired current through a fraction of the total inductance. This type of antenna system will be referred to as “stacked” multiple loops.

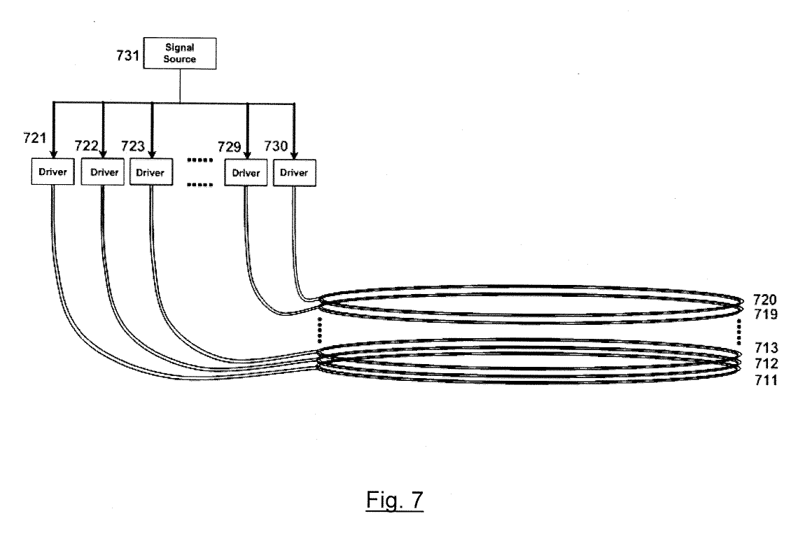

FIG. 7 shows an example of a “stacked” composite antenna loop comprised of several sub loops. In this example, there are ten sub loops, of which only five sub loops 711, 712, 713 . . . 719, 720 are shown for simplicity. Although shown spatially separated somewhat for clarity, it is advantageous if the ten sub loops 711 to 720 are situated in close proximity and with similar axes. In a loop antenna increased magnetic moment produces increase in range. Each sub-loop has its own corresponding driver, of which only five drivers 721, 722, 723 . . . 729, 730 are shown for simplicity. Each sub loop has one tenth the impedance of an equivalent single loop formed by connecting all ten loops in series. The current driven in each sub-loop will be ten times greater than that required from a single driver connected across a series combined loop. The ten drivers 721 to 730 must be designed with ability to generate (source) this higher current. For optimum performance the ten drivers 721 to 730 should provide signal currents in their corresponding sub loops that are substantially in phase with each other. This is easily achieved if the drivers are nominally identical and all supplied from the same common signal source 731.

An alternative method of antenna construction formed of multiple separate conducting loops so that larger magnetic moments may be achieved without requiring greater drive voltage, is described in United States patent application publication, 2009/179818 “Antenna formed of multiple planar arrayed loops”, Rhodes et al, the contents of which are hereby incorporated by reference. In this arrangement the area available for antenna deployment is occupied by a number of smaller loops deployed side by side in a common plane. The magnetic moment of these sub loops has a combined effect that is equivalent to a single large loop with an area equal to the combined sub loops. Again, the drive amplifier requirement for each sub loop is more manageable compared to a single amplifier designed to drive a larger single loop. This type of antenna system will be referred to as “planar” arrayed loops.

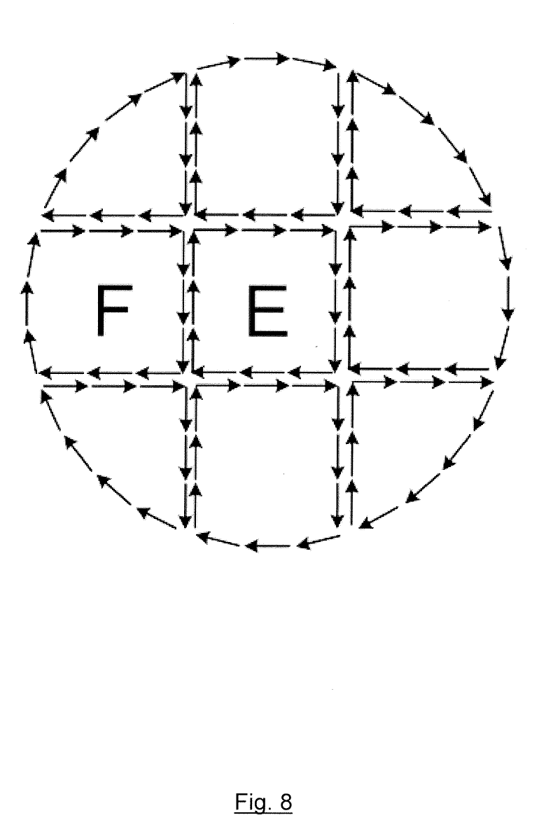

FIG. 8 illustrates a composite loop, divided into 9 smaller loops deployed in a single plane. The arrows illustrate the flow of current at any instant of time. Let us consider, for sake of simplicity, each sub loop driven by a constant current source. Loop E illustrates an embedded sub loop with no component at the periphery. The arrows indicate instantaneous flow of equal currents and it can be seen that each element of loop E has a neighboring current element which is equal in amplitude but of opposite direction. In this arrangement, each element of loop E generates electromagnetic fields that are exactly cancelled by those from adjacent current elements. The remaining 8 sub loops all have partial field cancellation in a similar manner. For example, loop F has cancelling currents along 3 of its 4 sides. It can readily be seen that the combined effect of the 9 sub loops is exactly equivalent to a single loop, of the same dimensions as the array periphery, driven with the same current. The main practical advantage of the array arrangement is in the reduced voltage required to drive the required current though each of the sub loops compared to a single large loop of area equal to the total combine loop area.

United States patent application publication, 2009/160273 “Antenna formed of multiple resonant loops”, Rhodes et al, the contents of which are hereby incorporated by reference, describes electromagnetic and/or magneto-inductive antennas formed of multiple separate conducting loops which are resonantly tuned and loosely coupled together for increased antenna bandwidth. This type of antenna system will be referred to as “multiple resonant loops”.

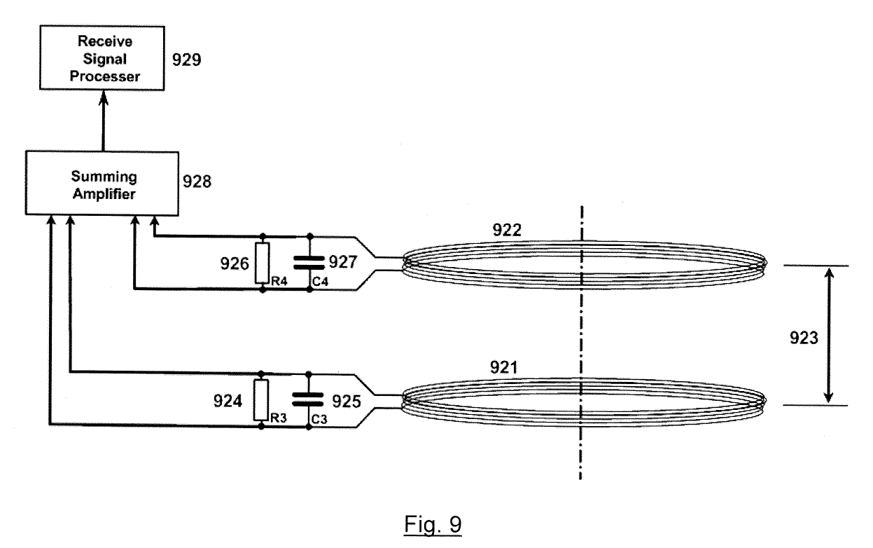

As depicted in FIG. 9, each of two receive loops 921, 922 which have partial mutual coupling by virtue of their physical spacing 923 may be brought to resonance by connecting across them respective parallel capacitors 925, 927. To control the Q value of each, respective parallel resistors 924, 926 may be included, where lower values of each resistor will decrease Q due to its parallel connection. Thus, two partially coupled parallel tuned circuits are created, and the voltage across each represents a contribution to the combined signal received by the antenna. The voltages are fed to the input of a summing device, which may be a summing amplifier 928. After summation, the aggregate signal can be further conveyed to whatever receive signal processing device 929 may be arranged to handle the signal.

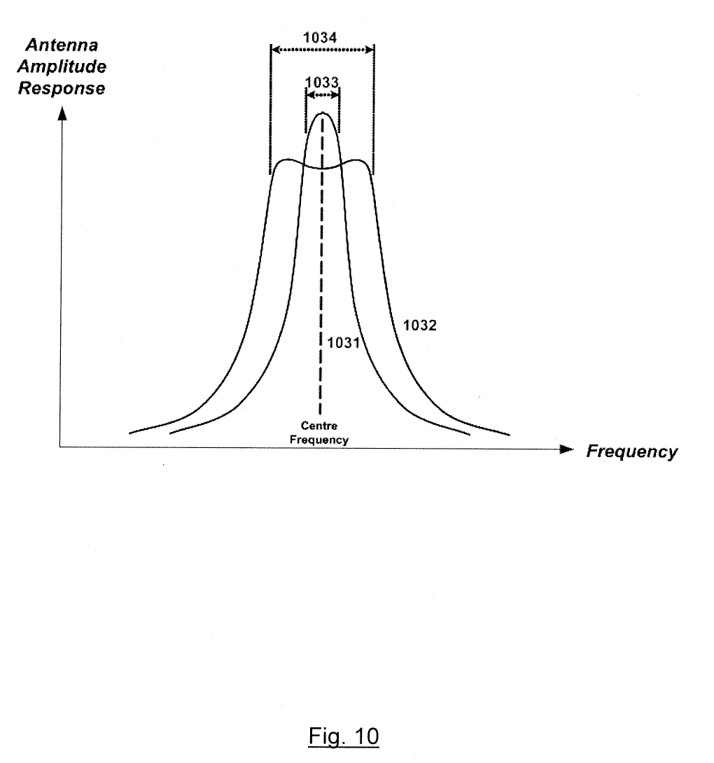

A typical signal response and bandwidth of this arrangement is depicted in one of the graphs of FIG. 10. The shape of the alternating current response 1031 is plotted on the graph with respect to frequency. It can be seen that the bandwidth likely to be useable about the centre frequency is limited to a relatively narrow range 1033. By changing the Q value it is possible to change the bandwidth somewhat. However, while a decreased Q will provide a wider bandwidth, this effect is at the expense of lesser signal gain. This trade-off between bandwidth and gain is undesirable, and it is one objective of this invention to provide an improved compromise.

A co located antenna system that is simultaneously optimized for transmit and receive performance is described in United States patent application publication, 2009/160725 “Antenna system with a co-located transmit loop and receive solenoid” Rhodes et al, the contents of which are hereby incorporated by reference. A large open cored loop is used for transmit with a high permeability, low conductivity cored solenoid used for receive. The solenoid is at least three times longer than its diameter and is arranged along the diameter of the large transmit loop. This type of antenna system will be referred to as “co located transmit-receive antenna”.

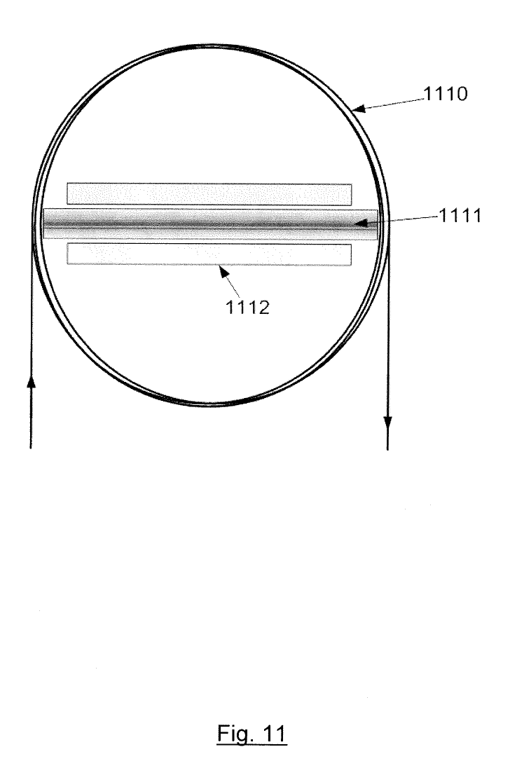

FIG. 11 illustrates the geometrical alignment of receive solenoid 1112 and transmit loop 1110. Receive solenoid is represented in cross section by the shaded section 1112. Many turns of wire, are wound around high permeability core 1111. Multi turn transmit loop 1112 generates lines of flux coming out of the page so does not saturate the receive coil. Receive coil 1112 and core 1111 are designed in terms of permeability, length to diameter ratio, number of turns and position of turns on the rod using principles well known to practitioners skilled in the art of low frequency radio antenna design and will not be repeated here since the design decisions are un modified by the mechanical arrangement which is the present subject of this invention. Similarly the number of turns used in the transmitting loop will be selected dependent on the available driving Voltage and the material of the wire loop to maximize the current * turns product.

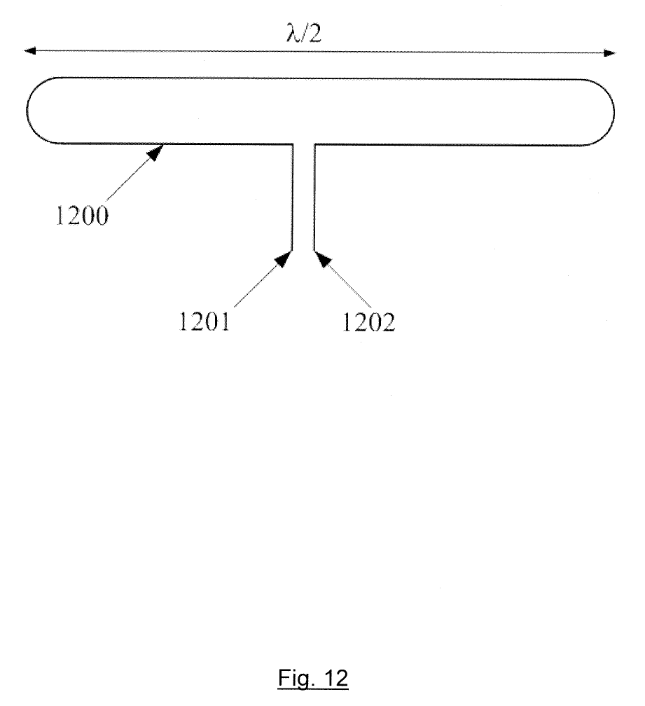

Another beneficial antenna may be based on a half wave folded dipole loop. FIG. 12 shows the basic construction of this class of antenna. Insulated wire loop 1200 is supplied with a balanced ac voltage across terminals 1201 and 1202. In situations where the operational wavelength results in practical λ/2 dimensions this type of antenna may be beneficial. This situation will occur for higher frequency operation for high bandwidth systems where wavelength is shorter or for deployments on large submerged or airborne structures. This type of antenna has a higher radiation resistance than an electrically small loop.

In all antenna constructions it must be recognized that wavelength is greatly foreshortened in a conductive medium as shown in equation 1.

λ=2π(πf μ₀ σ)^{-1/2} (1)
where: μ0=4π×10−7 H/m
σ=conductivity (S/m)
f=frequency (Hz).

Hence

λ=1,581×f^{-1/2} m

for typical sea water where σ=4 S/m

While the above discussion represents a two-way communications system between two participating vehicles it will be readily recognized that a similar system may be deployed in multiple vehicles. Multiple vehicles can form nodes of a network by implementing protocols familiar to those skilled in the field of digital radio communications.

Also, whilst the systems and methods described are generally applicable to seawater, fresh water and any brackish composition, because relatively pure fresh water environments exhibit different electromagnetic propagation properties from saline, seawater, different operating conditions may be needed in different environments. Any optimization required for specific saline constitutions will be obvious to any practitioner skilled in this area. Accordingly the above description of the specific embodiment is made by way of example only and not for the purposes of limitation. It will be clear to the skilled person that minor modifications may be made without significant changes to the operation described.

1. A system for digitally modulated radio communication directly between a submerged underwater station and an airborne station.

2. A system according claim 1, wherein each of said underwater station and said airborne station has or is associated with a radio communications antenna, each said antenna being one of: a loop antenna; a solenoid antenna; a stacked multiple loop antenna; a planar arrayed loop antenna; a multiple resonant loop antenna; a co located transmit receive antenna; or a half wave folded dipole antenna.

3. A system according to claim 2, wherein when said underwater station is immobile, said underwater station antenna or associated antenna is deployed so that it is substantially horizontal.

4. A system as claimed in claim 2, wherein when said underwater station is mobile, said underwater station antenna or associated antenna is positioned so that it is substantially horizontal when the direction of movement of the station is horizontal.

5. A system according to claim 2, wherein when said airborne station is immobile, said airborne station antenna or associated antenna is arranged so that it is substantially horizontal.

6. A system according to claim 2, wherein when said airborne station is mobile, said airborne station antenna or associated antenna is arranged so that it is substantially horizontal when the station is in level flight.

7. A system according to claim 2, wherein said airborne station is an aircraft.

8. A system according to claim 7 wherein said airborne station antenna or associated antenna is a loop antenna deployed from nose to wing tip to tail to wing tip to nose of said aircraft to maximize loop area.

9. A system according to claim 1, wherein said radio communications has a carrier frequency less than 100 kHz.

10. A system according to claim 1, wherein multiple communicating systems co operate to form a communications network.
